(19) United States
(12) Patent Application Publication
(10) Pub. No.: US 2004/0160186 A1
(43) Pub. Date: Aug. 19, 2004

(54) Plasma display panel filter

(76) Inventors: Kyochoong Cho, Suwon-si, Kyungki-do (KR); Dongyoung Kim, Cheonan-si, Chungcheongnam-do (KR); Chanhong Park, Seoul (KR); Young-Jin Lee, Anyang-si, Kyungki-do (KR)

Correspondence Address: David A Einhorn, Anderson Kill & Olick, 1251 Avenue of the Americas, New York, NY, 10020-1182, US

(21) Appl. No.: 10/480,524

(22) PCT Filed: Jan. 10, 2003
(86) PCT No.: PCT/KR03/00042

(30) Foreign Application Priority Data
Jan. 11, 2002 (KR) 10-2002-0001627

(51) Int. Cl. H01J 17/49

(52) U.S. Cl. 313/586; 313/582

(57) ABSTRACT

A plasma display panel (PDP) filter comprises an anti-reflection (AR) film, a near infrared (NIR) shielding film, a transparent substrate and an electromagnetic interference (EMI) shielding film, wherein the transparent substrate is a film laminate comprising at least two transparent plastic resin layers and at least one adhesive layer disposed between the plastic resin layers.

### FIELD OF THE INVENTION

The present invention relates to an optical filter for use on a plasma display panel (PDP), which has improved performance characteristics including high impact strength.

### BACKGROUND OF THE INVENTION

PDP is known to be more suitable for high definition television (HDTV) having an enlarged, flat frame than cathode ray tube (CRT) or liquid crystal display (LCD), but has the problems of: releasing harmful electromagnetic interference (EMI)/infrared (IR) emissions; high photopic reflection on the surface thereof; and lower color purity than CRT caused by orange light emitted from injected He gas. Accordingly, a filter has been applied in front of a plasma display panel to solve the above problems.

PDPs can be divided into two types, industrial PDPs (class A) and personal PDPs (class B), according to the EMI shielding ability. An industrial PDP filter is generally produced by alternately laminating a layer of a metal such as Ag and a layer of an oxide having a high refractive index on one side of a substrate to form EMI/IR shielding layers, and forming an anti-reflection (AR) layer on either the other side or both sides of the substrate. Japanese Patent Laid-open Publication No. 11-74683 discloses a preparation method of a personal PDP filter which comprises placing a conductive mesh between two transparent substrate layers, attaching an AR film on the viewer side of the substrate and an NIR shield film on the surface of the substrate opposite to the viewer side, and applying an AR film on the NIR layer. Japanese Patent Laid-open Publication No. 13-134198 also provides a method for producing a personal PDP filter which comprises successively attaching a conductive mesh and an AR film on the surface of a transparent substrate, and forming an NIR shielding layer on the other side of the substrate.

A tempered or semi-tempered glass plate having a thickness in the range of from 2.0 to 3.5 mm has generally been used as a substrate in the preparation of a PDP filter. However, such a glass plate has a specific gravity of 2.6 and it is difficult to produce a light-weight PDP filter. Accordingly, a plastic resin sheet such as an acryl plate has been proposed as a transparent substrate, but such a resin sheet has a low heat resistance.

Also, when a PDP filter is simply placed in front of a PDP, the air layer formed between the PDP and filter induces double reflection of incident rays to lower the contrast ratio.

To solve the above problems, Korean Patent Laid-open Publication No. 2001-39724 and Japanese Patent Laid-open Publication No. 13-33622 disclose a method of joining an electromagnetic shielding layer coated PET film directly on the front side of a PDP with a transparent adhesive. That is, a transparent PET film is employed as a light-weight, heat resistant substrate in the production of a PDP filter which can be directly attached on the face of a PDP.

However, a PDP filter produced by using a PET film as a transparent substrate has an impact strength which is too low to protect a PDP module from external impacts.

Accordingly, the present inventors have endeavored to develop a PDP filter having improved performance characteristics.

### SUMMARY OF THE INVENTION

It is, therefore, an object of the present invention to provide a light-weight PDP filter having an improved impact strength.

In accordance with one aspect of the present invention, there is provided a PDP filter comprising an anti-reflection (AR) film, a near infrared (NIR) shielding film, a transparent substrate and an electromagnetic interference (EMI) shielding film, wherein the transparent substrate is a film laminate comprising at least two transparent plastic resin layers and at least one adhesive layer disposed between the plastic resin layers.

### BRIEF DESCRIPTION OF THE DRAWINGS

The above and other objects and features of the present invention will become apparent from the following description thereof, when taken in conjunction with the accompanying drawings which respectively show:

FIG. 1: examples of the inventive transparent film laminate substrate, one having two transparent resin layers and a transparent adhesive film layer; and the other having three transparent resin layers and two transparent adhesive layers; and

FIG. 2: a schematic diagram of the PDP filter of Example 1 of the present invention, which comprises a transparent film laminate substrate.

### DETAILED DESCRIPTION OF THE INVENTION

The present invention provides a plasma display panel (PDP) filter comprising an anti-reflection (AR) film, a near infrared (NIR) shielding film, a transparent substrate and an electromagnetic interference (EMI) shielding film, wherein the transparent substrate is a film laminate comprising at least two transparent plastic resin layers and at least one adhesive layer disposed between the plastic resin layers.

The present invention is characterized in that a film laminate comprising at least two transparent plastic resin layers and one or more transparent adhesive layer disposed between the resin layers is employed as a transparent substrate in the preparation of a PDP filter, in order to improve the impact strength as well as optical properties, e.g., anti-reflection, electromagnetic interference cutting ability, NIR cutting ability and color purity.

The inventive PDP filter comprising at least two transparent plastic resin layers having high impact strength can be attached directly on the face of a PDP, and therefore, the present invention provides a light-weight, high-performance PDP filter that can protect a PDP unit from external impacts.

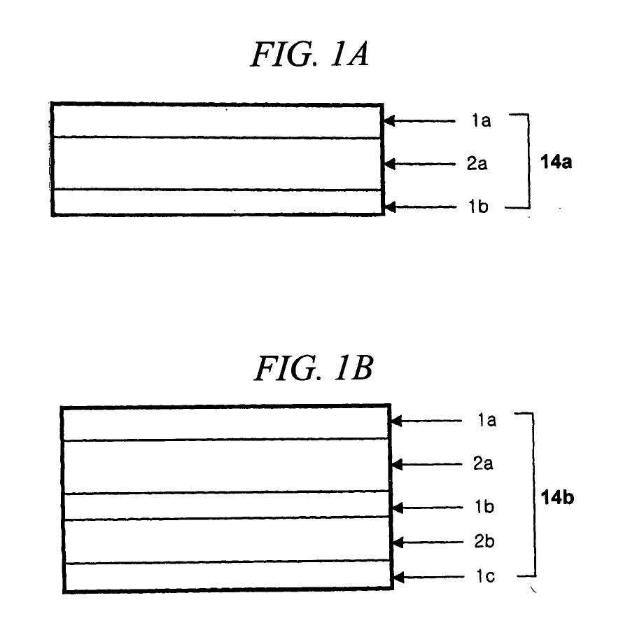

FIG. 1 shows examples of the inventive flexible film substrate comprising at least two transparent plastic resin layers and one or more transparent adhesive layer. The transparent film layer (1a, 1b, 1c) may be comprised of a thermoplastic resin, e.g., polyethyleneterephthalate (PET), polycarbonate (PC), polymethylmethacrylate (PMMA), triacetatecellulose (TAC), polyethersulfone (PES) or a mixture thereof, having a light transmittance of 80% or higher, preferably 90% or higher. The transparent plastic resin layer preferably has a thickness in the range of from 25 to 250 μm.

The transparent adhesive resin layer (2a, 2b) preferably has a thickness in the range of from 10 to 1000 μm, more preferably from 25 to 500 μm. Representative examples of the adhesive resin are ethylenevinyl acetate (EVA), ethylene (meth)acrylate, ethylenemethyl (meth)acrylate, metal ion crosslinked ethylene (meth)acrylate, carboxyethylenevinyl acetate, polyvinylbutylal (PVB) resin, epoxy resin, acryl resin, phenol resin, silicone resin, polyester resin and urethane resin, preferably ethylenevinyl acetate (EVA) and polyvinylbutylal (PVB) resin.

The transparent adhesive resin film is prepared in the form of a sheet by mixing the resins with such additives as UV or IR absorbents, followed by milling with an extruder or roll and flattening via roll coating or T-die coating. One or more of the adhesive film sheet thus obtained is placed between two or more transparent plastic films, followed by heating at a temperature in the range of from 70 to 200° C., preferably from 80 to 130° C. and pressing under a pressure in the range of from 1 to 10 kgf/cm², preferably from 2 to 5 kgf/cm² in a vacuum for about 30 minutes, followed by cooling to obtain a film laminate substrate (14). The vacuum may be 100 mmHg or less, preferably 10 mmHg or less.

Further, such a transparent adhesive as a pressure-sensitive adhesives (PSA) in the form of a film may be employed in the preparation of the PDP filter. The transparent adhesive may be an acryl or a thermoplastic elastomer. The adhesive may be used together with a UV cutting agent and other additives such as dyes, anti-deterioration agents or adhesive reinforcement agents.

The transparent adhesive may be coated on a transparent resin film by roll- or dye-coating, followed by drying and attaching to another transparent resin film to prepare a film laminate substrate.

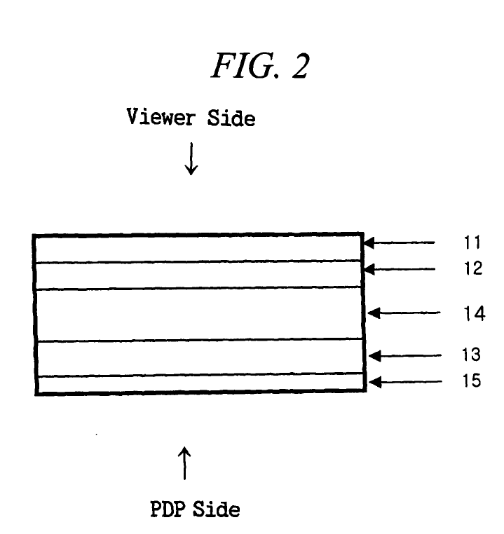

A preferred embodiment of the preparation of the inventive PDP filter is shown in FIG. 2.

On the viewer side of the transparent film laminate substrate (14), an NIR cutting/selective optical transmission film (12) and an AR film (11) are successively coated. An electromagnetic interference (EMI) shielding film (13) and a transparent adhesive film (15) are successively laminated on the other side of the substrate (14), to obtain the inventive PDP filter.

In the preparation of the NIR cutting/selective optical transmission film (12), selected optical absorbents and NIR cutting pigments may be added. Representative examples of the optical absorbent may be derivative pigments disclosed in Korean Patent Laid-open Publication Nos. 2001-26838 and 2001-39727. In such a pigment, a metal atom located in the center of tetrazaporphyrin is coordinated with one ligand selected from the group consisting of NH₃, H₂O and halogen, the metal being selected from the group consisting of Zn, Pd, Mg, Mn, Co, Cu, Ru, Rh, Fe, Ni, V, Sn and Ti. Representative examples of the NIR cutting pigment include a mixture of a Ni complex and a diimmonium compound, an organic pigment and a pigment containing Cu or Zn ion. Selected optical absorbent and NIR cutting pigment may be added in an amount of from 0.01 to 0.5% and from 0.3 to 5%, respectively, based on the total amount of the film. Further, conventional azo, cyanine, diphenylmethane, triphenylmethane, phthalocyanine, xanthene, diphenylene, indigoid or porphyrin dye may be added in the preparation of the film (12) in an amount of from 0.05 to 3% based on the total amount of the film.

A transparent resin and a dye may be dissolved in an organic solvent to be coated on the film laminate substrate (14), and form the NIR cutting/selective optical transmission film (12). The transparent resin may be poly(methyl methacylate)(PMMA), polyvinylalcohol (PVA), polycarbonate (PC), ethylenevinyl acetate (EVA), poly(vinylbutylal)(PVB) or polyethylene terephthalate (PET), and added in an amount of from 5 to 40% based on the amount of the solvent. Representative examples of the solvent include toluene, xylene, acetone, methylethylketone (MEK), propylalcohol, isopropylalcohol, methylcellusolve, ethylcellusolve and dimethylformamide (DMF). A stabilization agent such as a radical reaction inhibitor may be added to the film composition to prevent the degradation of the dye.

The coating process of the film composition may be carried out via a common coating technique, e.g., a roll-, dye- or spin-coating method. The thickness of the dried coating is preferably in the range of from 1 to 20 μm, more preferably from 2 to 10 μm, for attaining a satisfactory NIR cutting ability.

The NIR cutting/selective optical transmission film (12) may also be formed by coating an NIR film composition on one surface of a transparent resin laminate substrate and applying a transparent adhesive to the other side of the film (12) to a thickness of about 25 μm.

The AR film (11) may be formed by first coating a scratch-resistant acryl resin on one surface of a transparent film having a thickness in the range of from 75 to 250 μm, and then forming a low refractive index layer or forming transparent layers having high and low refractive index alternately, and applying a transparent adhesive to the other surface of the AR film (11) to a thickness of about 25 μm. A removal film (not shown in FIG. 2) may be attached on the transparent adhesive. The coating of the AR film may be carried out by a vacuum-coating, roll-coating or dye-coating process. The AR layer is preferably coated to a thickness of λ/4-λ/4 (λ: wavelength).

The EMI shielding film (13) may be prepared by applying a conductive mesh made of a metal fiber or a metal-coated fiber to one surface of a transparent film having a thickness in the range of from 75 to 250 μm, and applying a transparent adhesive to the other surface of the EMI shielding film (13) to a thickness ranging from 25 to 50 μm. Further, a transparent adhesive layer (15) having a thickness in the range of from 25 to 50 μm may be formed on the conductive mesh layer. The adhesive layer (15) may be used to join the PDP filter thus obtained to a PDP unit.

The present invention is further described and illustrated in Examples provided below, which are, however, not intended to limit the scope of the present invention.

Preparation of PDP Filters

### EXAMPLE 1

An EVA sheet (2a) (manufactured by Sekisui Chemical Co.; thickness: 250 μm) was sandwiched between two high transparent PET films (1a, 1b) (thickness: 125 μm), heated at 130° C. for 30 minutes in a vacuum of 10 mmHg or less, and pressed under 5 kgf/cm² to prepare a transparent laminate film substrate (14a) comprising two PET layers (FIG. 1A).

AN NIR/selective optical absorbent film (12) having a thickness of 125 μm comprising octaphenyltetraazaporphyrin (marketed as IRG022 by Nippon Chemical pharmaceutical Co.) as a dye was placed on one surface of the film substrate using a roll laminator at a rate of 1.0 m/min, and then, an AR film (11) having a thickness of 125 μm was put on the NIR/selective optical absorbent film (12) using a roll laminator at a rate of 1.0 m/min. To the other surface of the film substrate (14), a copper foil (13) having a mesh pattern (thickness: 125 μm, Line width: 10 μm, Line pitch: 300 μm, open area ratio: 93%) was applied, and a resin binder coated polyester film (15) was placed on the surface of the foil (13) layer using a roll laminator at a rate of 1.0 m/min to prepare a film laminate.

The film laminate thus obtained was put on a floating glass (thickness: 2.0 mm) using a roll laminator at a rate of 1.0 m/min, to obtain a PDP filter.

### EXAMPLE 2

The procedure of Example 1 was repeated except that two EVA sheets were respectively placed between three PET films to prepare a film substrate (14b) comprising three PET layers (FIG. 1B).

### EXAMPLE 3

The procedure of Example 1 was repeated except that high transparent PET films (thickness: 175 μm) were used, to obtain a PDP filter.

### EXAMPLE 4

The procedure of Example 2 was repeated except that high transparent PET films (thickness: 175 μm) were used, to obtain a PDP filter.

### COMPARATIVE EXAMPLE 1

A copper foil having a mesh pattern (thickness: 125 μm, Line width: 10 μm, Line pitch: 300 μm, open area ratio: 93%) was placed on one side of a high transparent PET film (thickness: 125 μm), and a resin binder and a transparent adhesive (thickness: 25 μm) were applied thereto in that order. On the other surface of the PET film, an NIR/selective optical absorbent film and an AR film were successively applied using the procedure of Example 1, to obtain a PDP filter.

Physical Characteristics

The properties of the PDP filters prepared in Examples 14 and Comparative Example 1 were measured with the methods described below, and the results are shown in Table 1:

(1) Visible Light transmittance (%): measured with a VIS spectrophotometer (manufactured by N&K Co., USA)

(2) Impact Resistance (1 bft): according to KS L 2016

TABLE 1

| | | VIS transmittance(%) | Impact resistance(lbft) |
|---|---|---|---|
| Example | 1 | 60 | 150 |
| | 2 | 55 | 170 |
| | 3 | 58 | 170 |
| | 4 | 53 | 200 |

| | | |
|---|---|---|
| Comp. Example 1 | 65 | 50 |

As can be seen from the above results, the plasma display panel (PDP) filter prepared in accordance with the present invention which comprises a film laminate comprising at least two transparent plastic resin layers as a transparent substrate has an improved impact strength and high light transmittance.

While the subject invention has been described and illustrated with respect to the preferred embodiments only, various changes and modifications may be made therein without departing from the inventive concept of the present invention which should be limited only by the scope of the appended claims.

What is claimed is:

1. A plasma display panel (PDP) filter comprising an anti-reflection (AR) film, a near infrared (NIR) shielding film, a transparent substrate and an electromagnetic interference (EMI) shielding film, wherein the transparent substrate is a film laminate comprising at least two transparent plastic resin layers and at least one adhesive layer disposed between the plastic resin layers.

2. The PDP filter of claim 1, wherein the transparent plastic resin layer has a thickness in the range of from 25 to 250 μm and a light transmittance of 80% or higher.

3. The PDP filter of claim 1, wherein the adhesive layer comprises a transparent adhesive resin or a transparent adhesive.

4. The PDP filter of claim 3, wherein the transparent adhesive resin is an ethylene vinyl acetate (EVA) or polyvinylbutylal (PVB) resin.

5. The PDP filter of claim 3, wherein the transparent adhesive is a pressure-sensitive adhesive (PSA) comprising an acryl compound or a thermoplastic elastomer.

6. The PDP filter of claim 3, wherein the film laminate is prepared by placing the transparent adhesive resin in the form of a sheet having a thickness in the range of from 25 to 250 μm between the substrate films, followed by heating at a temperature ranging from 70 to 200° C. and pressing under a pressure ranging from 1 to 10 kgf/cm².

7. The PDP filter of claim 1, wherein the anti-reflection (AR) film and the near infrared (NIR) shielding film are placed on the viewer side of the transparent substrate.

8. The PDP filter of claim 1, wherein the electromagnetic interference (EMI) shielding layer is placed on the side of the transparent substrate opposite to the viewer side.

9. The PDP filter of claim 1, which is attached directly on the surface of a plasma display panel using a transparent adhesive.
